(19) United States
(12) Patent Application Publication
(10) Pub. No.: US 2015/0182071 A1
(43) Pub. Date: Jul. 2, 2015

(54) Cookware Handling Device

(71) Applicants: Chris Charpentier, Cut Off, LA (US); Danny Charpentier, Cut Off, LA (US); Celeste Charpentier, Cut Off, LA (US); Dawn Charpentier, Cut Off, LA (US); Danielle Charpentier, Cut Off, LA (US)

(72) Inventors: Chris Charpentier, Cut Off, LA (US); Danny Charpentier, Cut Off, LA (US); Celeste Charpentier, Cut Off, LA (US); Dawn Charpentier, Cut Off, LA (US); Danielle Charpentier, Cut Off, LA (US)

(21) Appl. No.: 14/584,392

(22) Filed: Dec. 29, 2014

Related U.S. Application Data
(60) Provisional application No. 61/921,143, filed on Dec. 27, 2013.

(51) Int. Cl. A47J 36/34; A47J 45/10

(52) U.S. Cl. CPC A47J 36/34; A47J 45/10

(57) ABSTRACT

A cookware handling device is provided that comprises a surface that cradles a cookware item and functions as both a trivet and a potholder device. The device comprises a material formed from a template into a base surface and a plurality of upwardly projecting side portions that serve as handle grips for the cookware item. The side portions are formed together along sewn lines of connection, the lines of connection extending inward from the outer edges of the material. The lines of the connection dart the side portions together such that they extend upwards, while the base surface remains flat. The base surface and the side portions cradle a cookware article, while the outer extends of the side portions provide handle grips for lifting the device and the cookware article. The material of the device is a thermally insulative material that preferably includes an upper and lower covering material thereover.

### CROSS REFERENCE TO RELATED APPLICATION

This application claims the benefit of U.S. Provisional Application No. 61/921,143 filed on Dec. 27, 2013. The above identified patent application is herein incorporated by reference in its entirety to provide continuity of disclosure.

### BACKGROUND OF THE INVENTION

1. Field of the Invention

The present invention relates to potholders and hand shielding devices that provide a thermal barrier between a user and a heated cookware article. More specifically, the present invention relates to an elongated potholder that is configured to cradle a cookware article and provide upwardly flaring portions such that a user can lift the cookware article and thereafter support the same from its lower surface.

Potholders and trivets are known in the art. Potholders are devices that are either hand-worn or placed between the user and a cookware item when moving the item from a cooking environment. These devices insulate the user's fingers and hands, and allow the user to obtain purchase of the heated cookware item (e.g. pot, pan, tray, etc.) and move the item from the cooking area (e.g. an oven, stove, microwave, etc.). Similar, these devices allow the transfer of the cookware item to an eating area, if the food is one that is consumed or distributed directly from the cookware itself.

Trivets are similar cookware accessories that support heated items and separate the heated item from a sensitive support surface. The goal of the trivet is to separate the heated item from the support surface to prevent damage to the surface by way of direct heat conduction. The trivet provides a thermal barrier and a layer of resistance, whereby the trivet is placed under the cookware item and between the cookware item and the surface. Devices related to trivets include placemats and beverage coasters.

The art lacks an elegant solution for providing a combined trivet and a potholder device. The present invention is designed to fulfill this need by providing an assembly that acts as both a trivet and cookware handling device. The device is formed in a manner such that it cradles a heated cookware item while at the same time providing flared handle grips so the device and the cookware item can be carried without burning the carrier. The material of the present invention can be used within a microwave, or alternatively the device can be used to grasp heated cookware items from an oven. The device cradles the heated item and supports the same above any support surface, thereby acting as a trivet. The unique shape of the present invention facilitates this dual use.

2. Description of the Prior Art

Devices have been disclosed in the prior art that relate to potholders and trivets. These include devices that have been patented and published in patent application publications. These devices generally relate to supporting heated cookware items, but fail to disclose the unique configuration and utility of the present invention. The following is a list of devices deemed most relevant to the present disclosure, which are herein described for the purposes of highlighting and differentiating the unique aspects of the present invention, and further highlighting the drawbacks existing in the prior art.

One device in the prior art is U.S. Pat. No. 7,765,617 to Alden, which discloses a protective hand covering that is used to handle hot cookware items while baking or cooking. The assembly comprises a covering that extends over the fingers and thumb of the wearer's hand, and extends over the wrist of the wearer. A pair of pockets allows the fingers and thumbs to be disposed in opposing configuration for grasping, while stitching along the thumb pocket divides the pocket into multiple thumb compartments. The Alden device is indicative of potholders and hand coverings in the art, whereby the user dons the covering before handing hot items. By contrast, the present invention provides a hand covering and an insulated trivet device for heated cookware containers. The device cradles the cookware item while providing flared extension for handled grip of the cookware item during transfer.

Another device indicative of the art of trivets and cookware supports is U.S. Pat. No. 7,625,625 to Rios. Rios discloses a cookware grip that is comprised of cured silicone in connection with a foam or solid layer thereunder. The device can be applied to a container to prevent sliding, and further to insulate a support surface from the container. Devices similar to this are coasters, trivets, and other article supports. The present invention provides a device that serves as both a trivet and a potholder, providing both function for improved handling and insulated support. A cookware item can be cradled by the device and easily transferred from one are to another using the flared portions thereof.

U.S. Patent Publication No. 2006/0163264 to Wikstrom discloses a device for supporting and carrying a container, whereby the device comprises a base member and a central receiving portion for supporting a container therein. A plurality of legs extends downward from the device to allow the container to be supported above a support surface. Similarly, U.S. Pat. No. 5,884,883 to Millington discloses a handheld bowl lifter assembly comprises a rigid board having a semi-circular opening therein that intersects one side edge of the board. A container is positioned within the opening and the board is supported to carry a heated container without touching the same.

While the Wikstrom and Millington device provide assemblies for supporting and carrying heated containers, these devices fail to contemplate the structure of the present invention. The present invention comprises a formed potholder and trivet assembly, whereby an insulated material is sandwiched between an upper and lower covering. The assembly is sewn such that the edges thereof flare upward and outward. The interior of the assembly forms a bowl shape to cradle containers therein, while the edges are comprised of rounded portions that form handle grips.

It is submitted that the present invention is not anticipated or made obvious by the devices of the prior art. The present invention substantially diverges in design elements from the prior art, and consequently it is clear that there is a need in the art for an improvement to existing potholder devices. In this regard the instant invention substantially fulfills these needs.

### SUMMARY OF THE INVENTION

In view of the foregoing disadvantages inherent in the known types of cookware handling devices now present in the prior art, the present invention provides a new that can be utilized for providing convenience for the user when carrying or otherwise supporting a heated cookware article.

It is therefore an object of the present invention to provide a new and improved cookware handling device that has all of the advantages of the prior art and none of the disadvantages.

It is another object of the present invention to provide a cookware handling device that serves a dual function of a potholder and trivet device, whereby the device can be used to carry heated cookware items, and furthermore to support the heated cookware items on a table or countertop surface.

Another object of the present invention is to provide a cookware handling device that comprises a unique construction, whereby the device is formed such that it cradles a cookware item and provides handle grip locations along the sides of the cookware item for carrying the same.

Yet another object of the present invention is to provide a cookware handling device that includes a base surface and a plurality of side portions that extend upward and outward, terminating at a handle grip point that can be gripped by a carrying user.

Another object of the present invention is to provide a cookware handling device that comprises an insulated material that resists heat transfer from the cookware item to the outer surface of the device, whereby a user's hands are shielded from burns.

A final object of the present invention is to provide a cookware handling device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the cookware handling device of the present invention, along with a view of one contemplated cross section thereof.

FIG. 2 shows an underside perspective view of the cookware handling device of the present invention.

FIG. 3 shows the cookware handling device supporting a cookware item therein.

FIG. 4 illustrates how the cookware handling device is lifted and carried by way of its side portion handle grips.

FIG. 5 shows an overhead view of the cookware handling device of the present invention.

FIG. 6 shows an underside view of the cookware handling device of the present invention.

### DETAILED DESCRIPTION OF THE INVENTION

Reference is made herein to the attached drawings. Like reference numerals are used throughout the drawings to depict like or similar elements of the cookware handling device of the present invention. For the purposes of presenting a brief and clear description of the present invention, the preferred embodiment will be discussed as used for carrying and supporting heated cookware articles. The figures are intended for representative purposes only and should not be considered to be limiting in any respect.

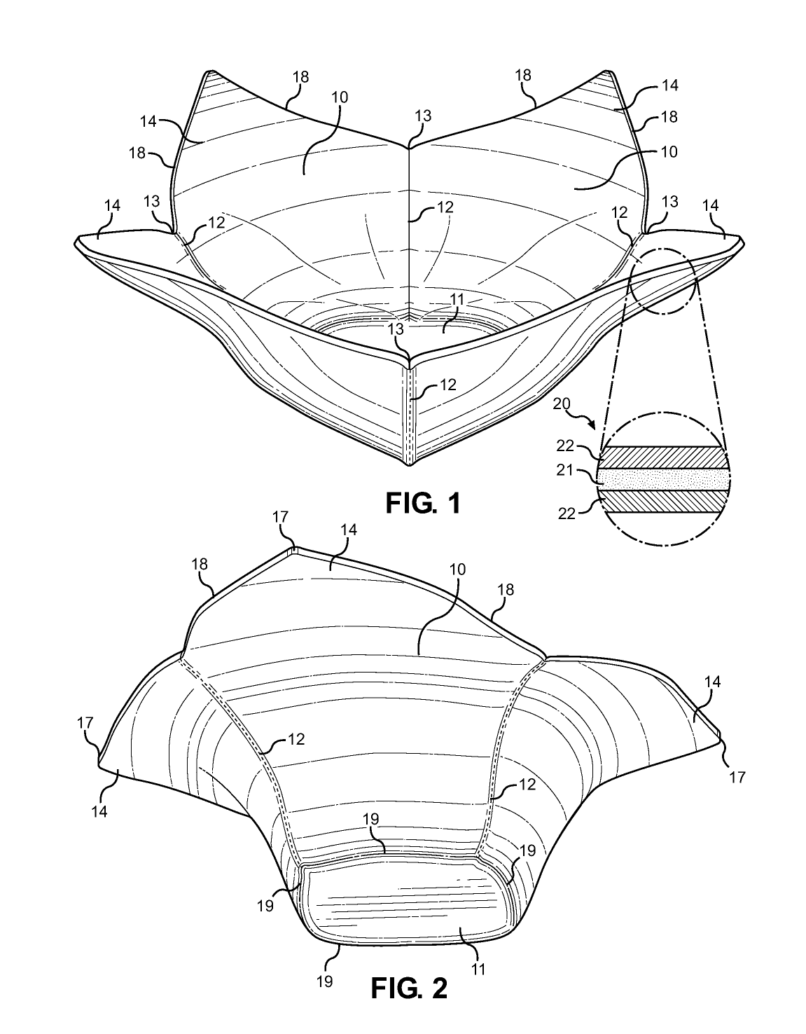

Referring now to FIGS. 1 and 2, there are shown perspective views of the cookware handling device of the present invention. The device comprises an elongated material that is formed into a concave shape having a base surface 11 and plurality of upwardly extending side portions 10 that flare upward and outward from the base surface 11. The side portions 10 are connected to the base surface 11 and preferably formed form a single, connected material that is first cut into shape in planar form and then formed into the concave shape shown in the figures. The side portions 10 comprises a lower edge 19 that abuts against the base surface 11, a pair of side edges 12, a pair of outer edges 18, and an outermost corner 17.

The outer portions are sewn together along their side edges 12 such that the side portions 10 flare upwards from the base surface 11. The surface of each side portion 10 and the outermost corner form a handle grip 14 for the user to grasp the device and lift the same as the base surface 11 supports a cookware item thereon. As a result, the cookware item is cradled within the interior of the concave device, whereby the base surface 11 supports the base of the cookware item and the side portions extend upwards along the sides thereof and provide handle grips 14 for the user to lift and support the cookware item.

When fabricating the cookware handling device of the present invention, a planar surface of thermally insulating material is cut from a pattern or template to form the base surface 11 and the side portions 10. The side edges 12 are separated from one another when in planar form, whereby the side edges are formed from a triangular cut into the material when laid flat. The triangle cut extends inward towards the base surface 11 and flares outward. The triangular cut is used to “dart” the side edges 12 together, whereby to join them together the side portions 10 must fold upwards so the side edges 12 align. Once aligned, the side edges 12 are sewn together, forming a sewn line of connection between side portions 10 and along adjacent side edges 12.

The outer edges 18 of the side portions 10 may comprise the pointed outermost corner 17 and pair of outer edges 18 as shown in FIGS. 1 through 6, or alternatively the outer edges 18 may form a rounded outer edge, squared, or similar shape. The preferred shape is that shown in the figures, whereby a pair of outer edges 18 extends outward from the termination 13 of the sewn line of connection between to form a pointed outermost corner 17. Similarly, the cross section 20 of the device may comprises single, insulating layer 21, or alternatively an insulating layer 21 sandwiched between an inner and outer material covering layer 22.

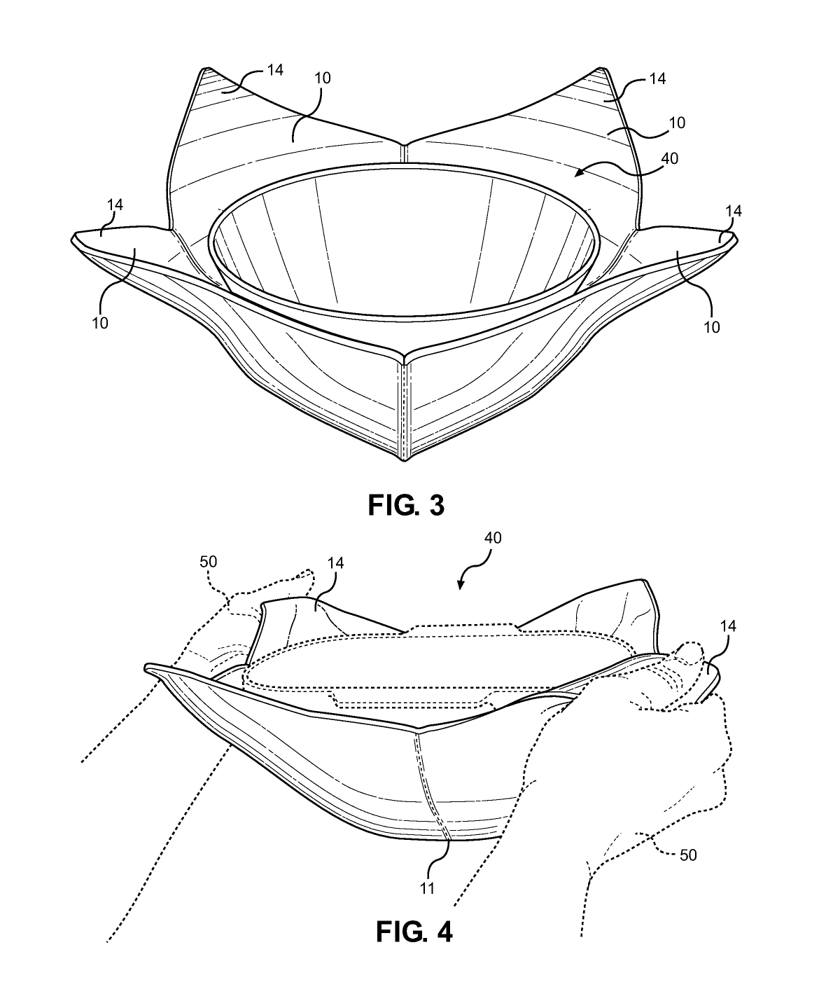

Referring now to FIGS. 3 and 4, there are shown views of the cookware handling device in a working state, supporting a cookware item 40 therein and being supported by a user 50 via the handle grip portions 14. The side portions 10 extend upward and outward from the base surface 11 such that the device forms a concave assembly for cradling and supporting a cookware item 40 therein. The outermost extent of each side portion 10 forms a corner and provides an area that serves as a handle grip 14. In use, the device is positioned under a cookware item and the handle grip portions 14 are used to lift and carry the cookware item 40 to a desired location.

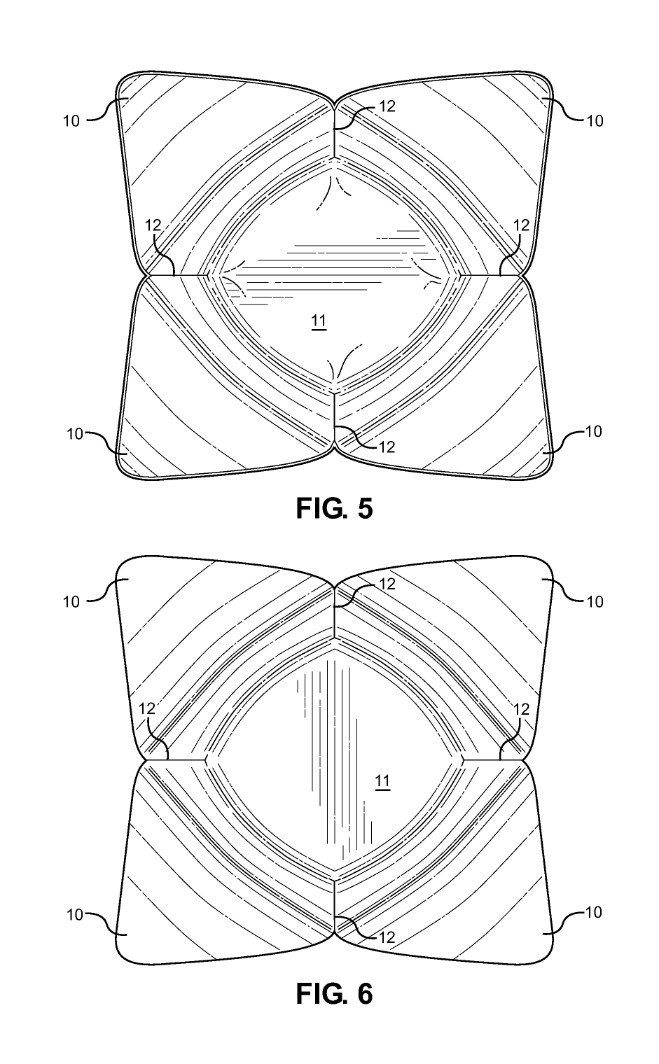

Referring finally to FIGS. 5 and 6, there are shown overhead and underside views of the present invention. The base surface 11 comprises a planar portion that is disposed between the side portions 10, which flare upwards and create the concave shape of the device. The base surface 11 may comprises a rounded, squared, rectangular, or alternative shape, whereby its purpose is to support the underside of a cookware item and separate the same form a table or countertop surface when not being used to carry the cookware item. The side edges 12 of the side portions 10 are sewn together to form sewn lines of the connection, which draw the side portions 10 together and maintain the side portions 10 in an upwardly flared state.

It can prove difficult to remove heated cookware items from an oven or from a microwave without a potholder or similar insulating barrier. Without an adequate thermal barrier, the heat from the cookware item can cause the unassuming user to drop the hot cookware item onto the floor, spilling its contents and damaging the cookware item. While conventional potholders are helpful, the present invention provides a combination device that facilitates carrying heated items and supporting the same along a table or countertop surface. The present invention serves as both a potholder and a trivet device, whereby its concave shape cradles the cookware item and allows the user to grip the handle grip locations and rest the cookware item on a surface while the device is still attached thereto.

The present invention is very useful when heating items in a microwave, whereby the material of the present invention is microwave safe and can be used in the microwave while the cookware item and food are heated. The user can thereafter grip the handle grip locations and lift the heated contents from the microwave oven. When used with a conventional oven, the user can utilize the device as a potholder until the cookware item is removed from the oven interior. Thereafter, the cookware handling device is positioned under the cookware item such that the item can be carried or supported therein.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A cookware handling device, comprising:
a base surface and a plurality of side portions flaring upward and away from said base surface to form a concave shape;
said side portions having a lower edge that abuts against said base surface, a pair of side edges, at least one outer edge, and a surface area forming a handle grip portion;
said side edges of each side portion being affixed to a side edge of an adjacent side portion;
said affixed side edges forming a line of connection;
said base surface and said side portions comprising a thermally insulating material.

2) The cookware handling device of claim 1, wherein said at least one outer edge comprises a pair of side edges forming an outermost corner.

3) The cookware handling device of claim 1, wherein said line of connection comprises a sewn line of connection.

4) The cookware handling device of claim 1, further comprises an upper and lower material layer coextensive with and covering said thermally insulating material.

5) The cookware handling device of claim 1, wherein:
said base surface and said plurality of side portions are fabricated from a planar template, whereby said side portions are formed using triangular cuts therebetween;
said triangular cuts separate said side edges and form said side edges thereof;
said side edges darted together to form said concave shape when said side edges are aligned and affixed together.
